(19) United States
(12) Patent Application Publication
(10) Pub. No.: US 2007/0088957 A1
(43) Pub. Date: Apr. 19, 2007

(54) Verifying provenance data associated with digital content

(75) Inventor: Douglas M. Carson, Cushing, OK (US)

Correspondence Address: Fellers, Snider, Blankenship, Bailey & Tippens;Suite 1700, 100 North Broadway, Oklahoma City, OK, 73102-8820, US

(73) Assignee: DC IP, LLC, Cushing, OK (US)

(21) Appl. No.: 11/495,975

(22) Filed: Jul. 27, 2006

Related U.S. Application Data
(60) Provisional application No. 60/702,821, filed on Jul. 27, 2005.

(51) Int. Cl. H04L 9/00

(52) U.S. Cl. 713/176

(57) ABSTRACT

Method and apparatus for verifying provenance data associated with digital content. The provenance data preferably comprises a number of entries that serve as a history of processing steps carried out upon the digital content, such as when and by whom the content was created, transmitted, mastered, replicated, etc. A hash function is preferably used to generate a multi-bit digital signature from the provenance data, and the provenance data and the digital signature are stored in a memory. A processor uses the digital signature to authenticate the provenance data, preferably by generating a second digital signature from the provenance data and comparing the second digital signature with the first signature. The processor further preferably authenticates the content in relation to the authenticated provenance data. The processor preferably further processes the content, updates the provenance data in relation thereto, and calculates a new digital signature in relation to the updated provenance data.

### RELATED APPLICATIONS

The present application makes a claim of domestic priority to U.S. Provisional Patent Application No. 60/702,821 filed Jul. 27, 2005.

### FIELD OF THE INVENTION

The present invention relates generally to the field of digital data storage and transmission and more particularly, but without limitation, to a method and apparatus for verifying provenance data associated with digital content.

### BACKGROUND

As will be recognized, digital data signals generally represent information using a series of discrete and quantized values. Digital data systems operate such that, once certain underlying information is expressed by a first digital signal, this information can subsequently be obtained through decoding efforts carried out to produce a second digital signal from the first signal.

In some cases, the first digital signal is used as an input to a recording operation to a data storage medium, such as an optical disc, magnetic media, etc., so that the second digital data signal is generated during a read operation upon the medium. In other cases, the first digital signal is used to frame a digital transmission such as via a network (e.g., the Internet), so that the second digital data signal is generated upon receipt of the transmitted communication.

It is becoming increasingly common to use digital systems to distribute digital signals representative of what can be generally referred to as “content,” or information adapted for use by an end user. In this context, content can include software, video, audio, and other types of works for which copyrights and other proprietary rights are held by the providers of such content.

A problem facing content providers is the ability to adequately control the replication of their content; that is, the unauthorized duplication, or “pirating,” of such content is of significant concern. This is exasperated by the fact that, generally, the digital contents of an original (master) may be identical to an unauthorized duplicate derived therefrom.

With regard to storage media (e.g., optical discs such as DVDs), it is generally difficult to determine if a particular set of content was pirated prior to mastering, during mastering or subsequent replication, or from the distributed optical media. With regard to transmitted content (e.g., such as over a network), it is similarly difficult to determine if a particular set of content was obtained from an authorized source, and whether the recipient is entitled to have received that particular copy.

### SUMMARY OF THE INVENTION

Preferred embodiments of the present invention are generally directed to a method and apparatus for verifying provenance data associated with digital content.

The digital content preferably comprises a digitally expressed work such as a software application, an audio-visual work, etc. The provenance data are preferably arranged as a number of entries that serve as a history of processing steps carried out upon the digital content, such as when and by whom the content was created, transmitted, mastered, replicated, etc.

In accordance with preferred embodiments, a multi-bit digital signature is generated from the provenance data, such as through the use of a hash function. The provenance data and the digital signature are stored in a memory, such as on an optical disc or in a memory of a networked system.

A processor preferably uses the digital signature to authenticate the provenance data. This is preferably carried out by generating a second digital signature from the provenance data and comparing the second digital signature with the first signature. The processor further preferably authenticates the content in relation to the authenticated provenance data. Further processing steps carried out upon the digital content preferably result in further updated entries to the provenance data and the calculation of new digital signatures in relation thereto.

In this way, the digital signature operates as a certificate of authenticity for the provenance data, indicating that the provenance data likely represent the true history of the digital content. The authenticated provenance data can then serve as a certificate of authenticity for the digital content.

These and various other features and advantages which characterize the claimed invention will become apparent upon reading the following detailed description and upon reviewing the associated drawings.

### BRIEF DESCRIPTION OF THE DRAWINGS

FIG. 1 shows an optical disc preferably characterized as a pre-recorded disc with digital content stored thereon, the content having associated provenance data in accordance with preferred embodiments of the present invention.

FIG. 2 provides a functional block diagram of a readback system adapted to read the disc of FIG. 1.

FIG. 3 shows a preferred format for the disc of FIG. 1.

FIG. 4 illustrates a sequence of steps preferably carried out during a manufacturing process used to create the disc of FIG. 1.

FIG. 5 shows a preferred format for provenance data generated in relation to the processing of FIG. 4 for the digital content, as well as a digital signature generated from the provenance data.

FIG. 6 sets forth an exemplary format for a selected provenance data entry from FIG. 5.

FIG. 7 sets forth a functional block diagram to illustrate a preferred manner in which the digital signature of FIG. 5 is generated.

FIG. 8 shows a memory configured to store the digital content, provenance data and digital signature as well as an associated processor.

FIG. 9 is a functional block diagram for a data transfer system preferably characterized as an Internet-based network.

FIG. 10 is a flow chart for a PROVENANCE DATA VERIFICATION routine, generally illustrative of steps carried out in accordance with preferred embodiments of the present invention.

### DETAILED DESCRIPTION

Generally, a method and apparatus are provided whereby provenance information (also referred to as “provenance data”) is generated for a selected set of digital content. The provenance data preferably serves as originating information associated with the generation and/or processing of the content, and is preferably embedded in digital form within the content at a selected location (or locations).

A unique digital signature is preferably generated for the provenance data by the application of a suitable function, such as a checksum, a cyclical redundancy code, a cryptographic hash function (signature), etc. This signature is thereafter used to validate the provenance data as accurately reflecting the true history of the content.

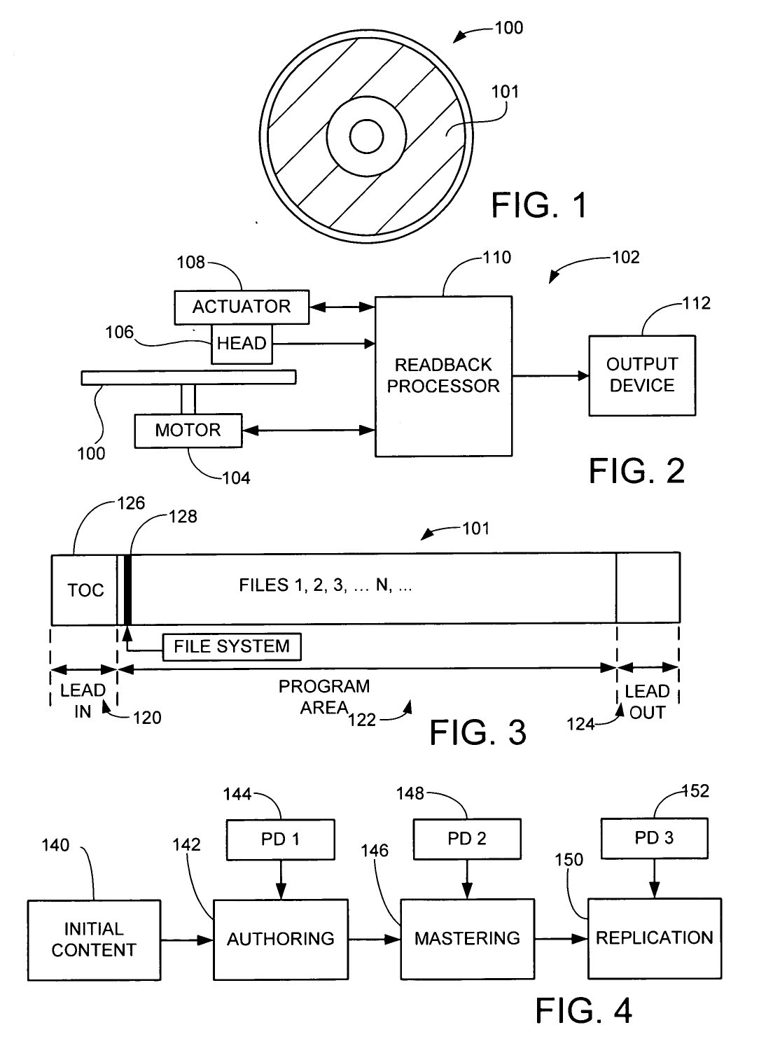

Exemplary preferred embodiments of the present invention place the content on an optical disc, such as an audio-visual (A/V) work (e.g., a full-length movie with associated data) on a single or multi-layer DVD. This is merely for illustration, however, and is not limiting. Such a disc is numerically shown at 100 in FIG. 1 and is contemplated as having been formed during a mastering/replication process whereby a population of nominally identical discs are formed and packaged for authorized distribution through normal commercial channels.

The disc 100 has a data storage area 101 in which data are stored along a number of concentric tracks that are preferably arranged along a continuous spiral. The tracks are accessed by a readback system 102 as shown in FIG. 2. The disc 100 is rotated by a disc motor 104, preferably at a constant linear velocity (CLV). An optical disc pick-up assembly comprises a data transducing head assembly 106 supported by a linear actuator assembly 108.

The pick-up assembly transduces optically detectable patterns from the data storage area 101 to provide a readback signal to processor circuit 110. The circuit 110 performs the appropriate signal processing and conditioning to provide an output signal to an output device 112. The output device 112 provides the content to a user in accordance with the format of said content (e.g., video output to a television or other video display, audio output to a receiver/speaker system, etc.).

The disc playback area 101 preferably has a format as shown in FIG. 3, with lead-in, program area and lead out zones 120, 122 and 124. The lead-in 120 includes a table of contents (TOC) 126 to identify the contents of the disc (start and end addresses, etc.). The program area 122 includes a number of files which are identified by a file system data block 128.

Preferably, during the manufacturing of the disc 100, a controlled content data space is defined. This data space can be any desired size, and is preferably set at 1 sector size (2048 bytes on DVD). The data space can be embedded into an existing file, or can be set apart as a separate file, as desired.

The data space preferably serves to accumulate provenance data associated with the generation of the master disc from which the replicated disc 100 is formed. For example, in a preferred embodiment, every activity associated with the processing of the content results in the appending of a log entry or other suitable indication.

This information can include time and date stamps, activities performed, results of such activities, operators and/or equipment involved, system or other transaction codes, etc. The information can be the above specific information, or can represent codes that then can be used to look up information in a separate database. In this way, the provenance data provides a detailed record of the origination and processing of the associated content. This is not limiting, however; in alternative embodiments, the provenance data can represent some other origination information associated with the content apart from the mastering of the discs that store such content.

FIG. 4 provides a flow diagram to illustrate a preferred manner in which the provenance data can be appended throughout the manufacturing process. Block 140 represents the initial generation of the program content. This is carried out by a content provider and may constitute software, video, audio, a combination of the foregoing, etc. Initially, no data are present at this point, so that a subsequent copy of this data can be identified as having been obtained prior to mastering. However, in an alternative embodiment an initial set of provenance data can be appended at this point prior to transmission to a mastering/replication facility.

Authoring block 142 represents receipt and processing of the content data by the mastering/replication facility. A set of data (PD 1) 144 is appended to the data in the data space, and may include time stamp or other transaction related data.

The content data are next mastered at block 146 by an LBR in the case of a pre-recorded embossed pit and land process, or written to a recordable medium in the case of recordable reproduction. This mastering step 146 preferably includes the appending of a second set of data (PD 2) 148, which may constitute a separate file, or an updating of the previously added provenance data. The resulting mastered disc thus includes data that describes the manufacturing process up to that point. Those skilled in the art will recognize that while only two steps are generally shown, depending on the environment any number of individual logging opportunities can exist up to the time of mastering, so that this is representational and not limiting.

Replica content (preferably on embossed or recordable discs) are next generated at block 150, and another set of data (PD 3) 152 is appended during this step as desired. It is contemplated that additional data can be added to the discs after shipment, such as by the end user (as a result, for example, of installation of the content onto a local disc drive, of initialization of the disc in a readback system of the user, etc.).

Significantly, the state of the provenance data at any given time advantageously presents the ability to subsequently determine whether a particular set of content are an authorized set, and if not, where in the manufacturing (or distribution) process the unauthorized copy was obtained. Techniques such as encryption and distribution of the data space across a number of different locations can be applied as desired to make it difficult to locate and decode the provenance data.

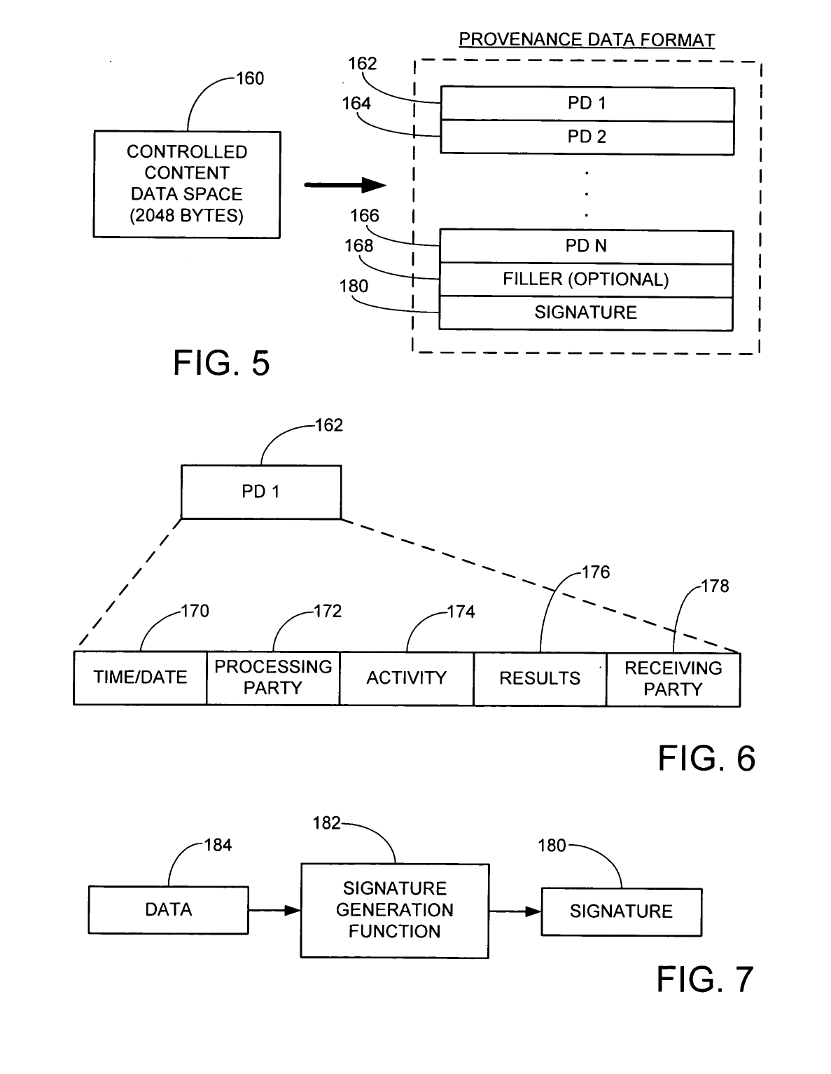

FIG. 5 provides a preferred provenance data format. The data space in which the data are stored is numerically denoted at 160. While the data space 160 is contemplated as being resident on the replicated disc 100 in the current example, such is not necessarily required; rather, in other preferred embodiments the data space can be provided in any memory location associated with the content such as a memory location of a computer network (not shown).

Individual entries of the provenance data from 1 to N are generally represented in FIG. 5 by blocks 162, 164 and 166. As desired, filler data (block 168) can be added to complete the filling of the data space 160. In embodiments that utilize such filler data, the filler data can be initially provided to the data space and portions thereof can be incrementally overwritten by successively added entries as additional space is needed. The filler data can alternatively be added after all of the provenance data have been written to the space.

An exemplary format for a selected provenance data entry is shown in FIG. 6 (in this case, the “PD 1” entry 162 from FIG. 5). The entry 162 includes a time/date stamp field 170, a processing party field 172, an activity field 174, a results field 176 and a receiving (handoff to) party field 178.

The field 170 generally identifies a date and/or time associated with the entry. Field 172 identifies the party, entity, individual, etc. which initially generated, received, or otherwise processed the content data at this step. Field 174 identifies the particular type of processing (activity) carried out with or upon the content. Field 176 identifies results, if any, that were obtained as a result of such processing, and field 178 identifies the next party in the chain of custody to receive the processed content. It will be appreciated that FIG. 7 is merely to provide an example in the context of the present discussion, and that other numbers and types of fields can readily be used for the provenance entries as desired.

Referring again to FIG. 5, a signature block 180 is shown appended to the end of the data space. The signature block 180 stores a signature formed from the provenance data (and any filler data, as desired) using a signature generation function as shown by block 182, FIG. 7. The signature preferably comprises a relatively short, fixed-sized signature pattern, such as 8 bytes.

The signature is preferably selected so as to be unique for each different possible input data set bit pattern. In this way, once a first signature is generated for a given input data set, if the input data set is subsequently altered and a new, second signature is generated for the altered data set, the second signature will not match the first signature. Any suitable generation functions can be used to generate the signature, including a checksum, a cyclical redundancy code (CRC) or a cryptographic hash function (cryptographic signature). Successive layers of functions can also be used.

As those skilled in the art will recognize, a checksum function generally operates to combine the numeric components of an input data set to provide a resulting value (sum). Variants such as the so-called “Fletcher's Checksum” provide some additional measure of bit position and ordering detection, but nevertheless operate to sum or otherwise combine the numeric components of the input data set to arrive at a final result.

CRCs generally utilize division in a commutative ring, namely a ring of polynomials over the integers modulo 2, to arrive at the resulting value. More particularly, the input data set is treated as coefficients to a polynomial, this polynomial is divided by another fixed polynomial to provide a remainder polynomial, and the coefficients of the remainder polynomial constitute the result.

A cryptographic hash function generally operates to take an input string of any length and produces a fixed length output therefrom. Preferably, the function is selected to operate as a random function while remaining deterministic and efficiently computable. As those skilled in the art will appreciate, any number of functions can be utilized as a cryptographic hash function.

It is preferable that such a function exhibit preimage resistance; that is, for a given hash function result (signature) “s” it should be difficult to determine the corresponding message “m” such that s=hash(m). It is further preferable that the function exhibit collision resistance; that is, for a given message “m₁,” it should be hard to find another message “m₂” not equal to m₁ such that hash(m₁)=hash(m₂).

In this way, even if both the input data set and the signature are both known to a third party, the third party will not be able to successfully alter the input data set and calculate a new signature therefrom that will be adjudged as a valid signature by applying the associated hash function.

The signature generation function of block 182 is preferably maintained in a confidential state by the content provider. The function is preferably selected to provide the output signature in such a way that examination of the signature (block 180) and the input data (block 184) will not readily reveal the underlying function.

It will be noted that the signature (whether cryptographic or otherwise) is different from the application of encryption to the entire data space; while both are preferably applied, this is not necessarily required. In further preferred embodiments, once the signature has been generated, error correction codes are applied to the data space (i.e. to both the provenance data and the signature). In this way, upon recovery of the contents of the data space an error detection and correction operation can be performed to provide a reasoned conclusion that the correct bit patterns for the provenance data and the signature have been recovered.

An advantage of the use of a signature in conjunction with the provenance data is that it can be readily determined whether tampering has taken place with regard to the provenance data, irrespective of the specific contents of the provenance data. By way of illustration, consider a situation where a pirating party creates an unauthorized disc from the authorized disc 100 discussed above. Generally, the pirating party will likely have done one of the following with regard to the data space 160:
1) He will have copied the contents of the data space, including all of the provenance information and the signature, exactly as in the original disc 100;
2) He will have zeroed out or otherwise completely changed the contents of the data space and the signature as compared to the original disc 100 so as to “erase” the provenance information; or
3) He will have selectively modified the contents of the data space in an attempt to provide “fake” provenance information that otherwise appears to be valid.

Recall that the provenance information, by itself, is useful in determining where in the chain of mastering/distribution an unauthorized copy appeared. The addition of the signature advantageously allows an assessment to be made as to the validity of such information.

Thus, under scenario no. 1 above, because the provenance data is unchanged from the original from which the pirated copy was taken, it can be readily determined where the unauthorized copy originated. Depending upon the “resolution” of the provenance data, the universe of potential sources can be reduced considerably, even to the point of identifying the specific original disc (e.g., such as if individual IDs were provided on a per copy basis).

It will be noted that this example sets forth a forensic test, not necessarily a copy protection test; that is, it is contemplated that in some cases there will be reason apart from the disc (or copy of content) itself to believe that this may be an unauthorized copy. In this situation, it can be safely concluded that the provenance data accurately reflect the history of this particular copy of the content. Thus, the ability to verify the provenance data as itself being authentic allows investigation efforts to rely on the provenance data in tracking down the source of the unauthorized copy. On the other hand, it will be appreciated that the authenticated provenance data can be used in other circumstances to identify the content as comprising an authorized copy.

Continuing with the present example, under scenario no. 2 above it will be clear that the provenance data has been intentionally modified in an attempt to “hide” the source of the original from which the unauthorized copy was made. Of course, this would also be apparent without the use of the signature.

Under scenario no. 3 above, because the signature generation function is unknown (and preferably undiscoverable), the signature with the unauthorized copy will not likely match a newly calculated signature on the provenance data, allowing a ready methodology for detecting whether the provenance data has been tampered with, and can thus be trusted (or not).

In a preferred embodiment, the readback system 102 (FIG. 2) is configured by the programming stored in the program area 101 to access the data space 160, calculate a signature using the signature generation function of block 182 (FIG. 7), and compare this signature to the original signature recovered from the data space 160. If the signatures match, then access is granted to the content on the disc 100.

FIG. 8 shows another illustrative embodiment in which the foregoing approach is adapted to provide provenance data verification for digitally transmitted content. FIG. 8 shows a set of digitally expressed data 200 resident in an associated memory 201. The data 200 include digital content 202, provenance data 204, and an associated signature 206. The memory 201 is accessible by an associated processor 208 which operates upon the data 200 as explained below.

The digital content 202 can take any number of forms, such as a software application executable on a personal computer (PC), a downloadable audio/visual work (e.g., a full length movie playable on a PC or other device), etc. Preferably, the provenance data 204 and signature 206 are embedded within the digital content 202 and are formatted as discussed above.

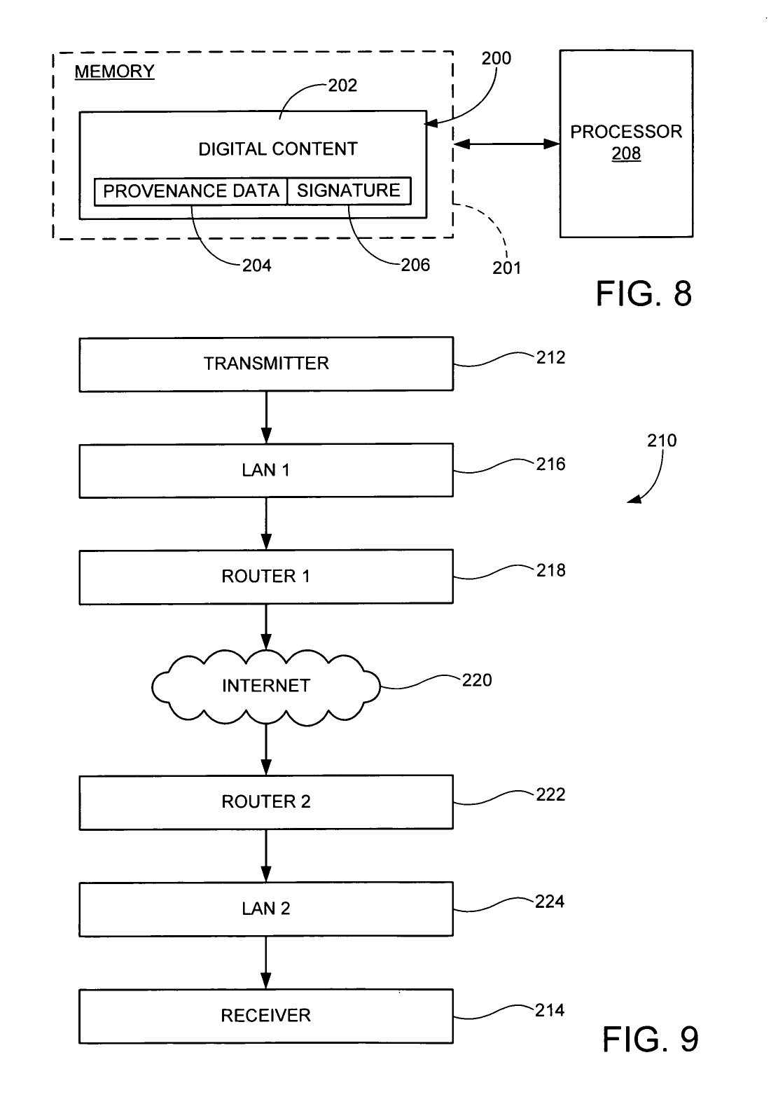

FIG. 9 sets forth an exemplary digital data transfer system 210 over which the data 200 are transferred from a transmitter 212 to a receiver 214. In the present example, each of the respective transmitter and receiver 212, 214 is a network coupleable device such as a PC, a file server, a laptop, a handheld portable entertainment device, a gaming system, etc. While the system 210 is shown to be Internet-based, such is illustrative and not limiting.

In order to transmit the data 200 to the receiver 214, the transmitter 212 preferably breaks the data down into a succession of fixed sized packets which are directed via a local area network (LAN 1) 216 to a first router (Router 1) 218. The router 218 directs the packets through Internet 220 to a distal router (Router 2) 222.

As will be appreciated, the path taken by each packet within the Internet 220 may be different based on loading and other factors, but generally each packet will in turn tunnel to a main backbone (not shown), pass along the backbone and then tunnel to the distal router 222.

The receiver 214 will reassemble the packets to provide the initially forwarded data 200. If encryption or other security actions are taken during the transfer process, the receiver 214 decrypts or otherwise processes the received data to obtain the digital content 202, provenance data 204 and signature 206.

Since a user at the receiver 214 may have initiated the data transfer process by issuing a request for the data 200, in preferred embodiments information associated with the receiver such as a host IP address, unique time/date stamp, user identifier, unique serial number etc. is used to generate a provenance data entry that is added to the provenance data 204, and the signature 206 is calculated in relation thereto prior to transmission.

The receiver 214 preferably reads the provenance data 204, calculates a signature therefrom and compares this signature to the received signature. Access is preferably granted if the signatures match. The signature generation function (block 182, FIG. 7) is preferably embedded within the transmitted digital content 202 or sent as a separate file from the transmitter 212. Alternatively, the receiver 214 decodes the received provenance data 204 and forwards this string back to the transmitter 212 (or other processor) for remote generation of the second signature. The second signature can then be returned to the receiver 214 for comparison or other further processing.

Subsequent transfer(s) of the received data 200 from the receiver 214 to another device are preferably carried out in a similar fashion; that is, the provenance data 204 are updated (preferably automatically) upon activation of the content 202 on a new system, thereby creating an internal log of where the data 200 have been passed.

Depending upon the circumstances, care should generally be taken to permit users to generate a backup copy when permitted to do so by applicable local laws. Indeed, the provenance data can be specifically updated to reflect the fact that a backup copy has in fact been made, and can further serve to identify a particular copy as an authorized backup copy. Both originally received and backup copies are preferably tailored to only execute on authorized machines, such as the receiver 214.

When the content 202 is a software application transmitted to an end user, it is contemplated that the data 200 can be received as an executable file that carries out a self-installation process onto the receiver 214. The installation itself can be logged as a provenance data entry, and verified as described above.

By contrast, when the content 202 is transmitted to the end user as an audio-visual work such as a full length movie, the user may be given the option to transfer the data 200 to a portable medium such as a recordable DVD. In such case, the provenance data are preferably updated with an entry to indicate the authorized recording of the data to that medium.

The system 210 of FIG. 9 can also be advantageously used to transmit original content from a content provider to a mastering facility for the generation of a master disc and/or a population of replicated discs (or other media). In such case, upon transmission the provenance data 204 reflects the initial configuration of the content 202 and the provenance data are subsequently updated in relation to the downstream processing applied to the content such as discussed above in FIG. 4.

In each case, the provenance data generally provides a history of the processing that has taken place upon the content, and the signature indicates whether this history is trustworthy. Stated another way, the provenance data preferably serves as a certificate of authenticity for the associated digital content, and the signature preferably serves as a certificate of authenticity for the provenance data.

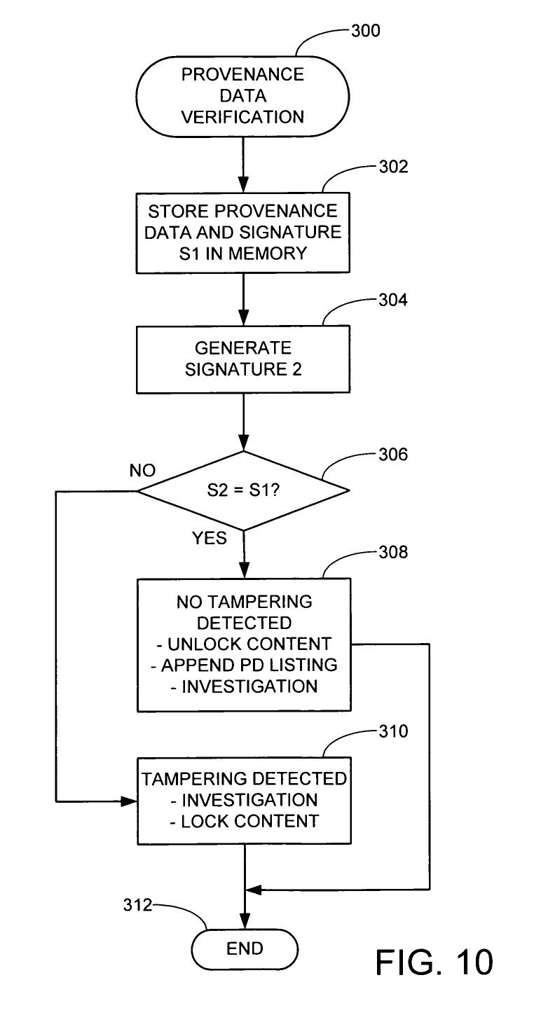

FIG. 10 provides a flow chart for a PROVENANCE DATA VERIFICATION routine 300, generally illustrative of steps carried out in accordance with preferred embodiments of the present invention. It is presumed that a data space such as 160, 201 has been formatted in accordance with the foregoing discussion and is now associated with a set of content, such as on storage medium 100, as part of a network communication transfer via system 210, etc.

At step 302, the contents of the data space are first retrieved. If encryption, error correction and/or other techniques are employed as discussed above, such measures are decoded to arrive at the actual multi-bit patterns for the provenance data (and filler) and the signature. For purposes herein, the original signature retrieved during step 302 will be referred to as the “first” signature S1.

At step 304, a second signature S2 is generated from the retrieved data bit pattern. This is preferably carried out by applying the function of block 182 (FIG. 7) to said pattern. At step 306, the second multi-bit signature S2 is compared to the first multi-bit signature S1. If these match, the flow continues to step 308 where the provenance data are certified as being authentic; that is, it is concluded that no tampering has taken place with regard to the provenance data associated with the content under consideration, so that the provenance data can be relied upon to correctly reflect the history of the content to that point.

The actual steps that take place in response to the conclusion that no tampering has occurred will depend upon the circumstances and environment. For example, if the routine 300 is carried out as part of an executable launch program, then the contents can be unlocked to allow user access thereto.

If the routine 300 is carried out during a content processing flow (such as a mastering operation such as set forth by FIG. 4), then additional provenance data are appended to the data space in accordance with the various process steps carried out upon the content.

If the routine 300 is carried out during a forensic investigation of a disc suspected to be an unauthorized copy, then the provenance data are used to help determine the point in the manufacturing or distribution flow from which the unauthorized copy was obtained.

Returning to decision step 306, if the signatures S1 and S2 do not match, the flow continues to step 310 where tampering is detected with respect to the provenance data, which indicates that the provenance data should not in fact be relied upon as correctly reflecting the true processing history of the content. Depending on the circumstances, this may result in a locking of the content so that further access is denied, and/or a forensic investigation into sources that could have provided the unauthorized copy with the knowledge and skill to locate and modify the provenance data. The process then ends at step 312.

It will now be understood that the foregoing preferred embodiments provide a powerful and readily implementable apparatus and associated methodology for verifying the authenticity of provenance data associated with digital content. This approach can readily be incorporated into existing processes used to create, transmit, master and distribute content to various markets.

One particularly useful application, as discussed above, is the Internet transfer of content from a content provider to a mastering facility. The content provider and the mastering facility can each readily ensure that the origination information provided by the provenance data correctly reflects the actual history, source, etc. of the content.

Another particularly useful application is the distribution of downloaded content (such as via the Internet) to third parties. A content provider can include the provenance data for a particular end user in the data space sent with the content, including the automatic updating of the machine to which the data have been sent as part of the provenance data set. Thus, attempts to operate the content on another machine may result in a rejection of access to that software.

For purposes of the appended claims, the recited first means will be understood to correspond to at least the disclosed processors 110, 208 in accordance with the routine of FIG. 10. The term “digital signature” will be construed consistent with the foregoing discussion as an output of a function applied to the provenance data to provide a fixed sized pattern that uniquely identifies the provenance data. Error detection and correction codes can be applied to the provenance data (and the signature as desired), but such codes will be readily understood as distinct from, and not constituting, a signature.

It is to be understood that even though numerous characteristics and advantages of various embodiments of the present invention have been set forth in the foregoing description, together with details of the structure and function of various embodiments of the invention, this detailed description is illustrative only, and changes may be made in detail, especially in matters of structure and arrangements of parts within the principles of the present invention to the full extent indicated by the broad general meaning of the terms in which the appended claims are expressed.

What is claimed is:

1. A method comprising steps of:
storing, in a memory, provenance data associated with a set of digital content and a separate, multi-bit digital signature generated from the provenance data; and
authenticating the provenance data in relation to the digital signature.

2. The method of claim 1, further comprising a step of authenticating the set of digital content in relation to the authenticated provenance data.

3. The method of claim 1, wherein the provenance data comprises a plurality of entries each associated with a different processing step carried out with respect to the set of digital content.

4. The method of claim 3, wherein each of said entries comprises an associated time/date stamp indicative of when the associated processing step was carried out.

5. The method of claim 1, wherein the digital signature is generated using a hash function.

6. The method of claim 1, wherein the digital signature is characterized as a first digital signature, and wherein the authenticating step comprises applying a signature generation function to the provenance data to generate a second digital signature, and comparing the second digital signature to the first digital signature to authenticate the provenance data.

7. The method of claim 1, wherein the memory comprises an optical disc.

8. The method of claim 1, wherein the memory forms a portion of a receiver, and wherein the storing step comprises transmitting the digital content, the provenance data and the digital signature across a network from a transmitter to said receiver.

9. The method of claim 1, wherein the digital content comprises a software program configured for execution by a computer.

10. The method of claim 1, wherein the digital content comprises an audio-visual work.

11. An apparatus comprising
a memory which stores provenance data associated with a set of digital content and a separate, multi-bit digital signature generated from the provenance data; and
a processor coupled to the memory which authenticates the provenance data in relation to the digital signature.

12. The apparatus of claim 11, wherein the processor further authenticates the set of digital content in relation to the authenticated provenance data.

13. The apparatus of claim 11, wherein the provenance data comprises a plurality of entries each associated with a different processing step carried out with respect to the set of digital content.

14. The apparatus of claim 11, wherein the digital signature is generated by a second processor which applies a hash function to the provenance data prior to storage of the provenance data and the digital signature in the memory.

15. The apparatus of claim 11, wherein the digital signature is characterized as a first digital signature, and wherein the processor applies a signature generation function to the provenance data to generate a second digital signature, and compares the second digital signature to the first digital signature to authenticate the provenance data.

16. The apparatus of claim 11, wherein the signature generation function is stored in the memory and accessed by the processor.

17. The apparatus of claim 11, wherein the memory comprises an optical disc.

18. The apparatus of claim 11, wherein the memory and the processor form a portion of a receiver, and wherein the digital content, the provenance data the digital signature are transferred across a network from a transmitter to said receiver.

19. The apparatus of claim 11, wherein the processor further processes the digital content, updates the provenance data in relation to said processing, and generates a new digital signature in relation to the updated provenance data.

20. An apparatus comprising a memory which stores provenance data associated with a set of digital content and first means for authenticating the provenance data in relation to the digital signature and for authenticating the set of digital content in relation to the authenticated provenance data.
